(19) United States
(12) Patent Application Publication
(10) Pub. No.: US 2015/0125654 A1
(43) Pub. Date: May 7, 2015

(54) METHOD FOR MANUFACTURING A T-SHAPED COMPOSITE PART BY RESIN-TRANSFER MOLDING

(71) Applicant: AIRCELLE, GONFREVILLE L'ORCHER (FR)

(72) Inventors: Didier LERETOUR, MANNEVILLETTE (FR); Sébastien LOUCHARD, LE HAVRE (FR); Laurent DUBOIS, LE HAVRE (FR); Claire DUPUIS, LE HAVRE (FR)

(21) Appl. No.: 14/598,546

(22) Filed: Jan. 16, 2015

Related U.S. Application Data
(63) Continuation of application No. PCT/FR2013/051673, filed on Jul. 12, 2013.

(30) Foreign Application Priority Data
Jul. 20, 2012 (FR) 12/57069

(51) Int. Cl. B29C 70/48; B32B 3/26; B32B 3/08

(52) U.S. Cl. CPC B29C 70/48; B32B 3/08; B32B 3/263; B32B 2260/00; B29K 2105/08
USPC 428/120; 264/325

(57) ABSTRACT

A method for manufacturing a T-shaped composite part by resin transfer molding, includes the following steps: making a preform with a planar stack of plies and with two L-shaped stacks of plies; placing the preform so that the L-shaped stacks meet between two cores of a resin transfer molding tool; inserting and removing fibers through the planar stack in a direction perpendicular or quasi-perpendicular to the planar stack and so that loops are formed inside a portion of the L-shaped stacks which are substantially perpendicular to the planar stack; closing the resin transfer molding tool; injecting a resin into the resin transfer molding tool; and heating the resin transfer molding tool to cure the resin.

### CROSS-REFERENCE TO RELATED APPLICATIONS

This application is a continuation of International Application No. PCT/FR2013/051673, filed on Jul. 12, 2013, which claims the benefit of FR 12/57069, filed on Jul. 20, 2012. The disclosures of the above applications are incorporated herein by reference.

### FIELD

The present disclosure relates to the field of manufacturing parts in composite materials, in particular for aeronautics.

### BACKGROUND

The statements in this section merely provide background information related to the present disclosure and may not constitute prior art.

Parts in composite materials can be made from tissues (frequently called “plies”) of fibers in particular of carbon or glass, which are impregnated with resin (polyimide for example), which is then polymerized by raising the temperature in autoclaves.

In this way, parts that can practically have any geometry, as well as an excellent combination of resistance/weight, are obtained.

Different resin impregnation techniques exist: pre-impregnated resin plies, or resin transfer methods can be used.

Such methods, commonly used for the manufacturing of parts in aeronautics, are generically referred to as RTM (“Resin Transfer Molding”).

This technique consists of placing a preform constituted by an assembly of plies within a closed mold, in which resin is injected under pressure. This resin thus progresses through the plies, and fills progressively all the available interstices. Once this filling completed, the temperature of the mold is raised so that to cure the resin.

This technique is used in particular for the manufacturing of T-parts, that is to say of parts comprising two sections 1, 2 substantially perpendicular to each other, as it is seen in FIGS. 1 and 2 appended hereto.

Such parts may be used in particular for the manufacturing of beams.

More specifically, to manufacture such a part, three stacks of plies are used: a substantially planar stack A, and two substantially L, B and C-shaped stacks, the latter two being joined so that to define the base of the T.

When the preform constituted by the stacks A, B and C is impregnated with resin, the formation of a resin cluster 3 is commonly observed in the junction area of these three stacks.

This resin cluster, devoid of fibers, is a weak point of the part obtained in fine: it may indeed be the cause of a delamination of the surrounding plies, and limits the resistance to tensile forces tending to separate the stacks B and C from the stack A (arrow 5 on FIGS. 1 and 2).

To overcome these drawbacks, two solutions to this date are used. The first solution consists of pre-filling the junction area of the three stacks of an assembly of fibers held together: this solution, called “of the nail head” with respect to the shape of the cross section of said junction area, creates numerous difficulties in the context of an industrial process. For example, the added fibers can move during the resin injection, and finally occupy positions which are not optimal towards the resistance to the external forces.

The second solution consists of sewing together the stacks A, B, C in their junction area, as it is seen on FIG. 2 (stitches 7). This solution has the drawback of being able to be implemented only before the setting up of the preform constituted by the stacks A, B, C on the RTM mold, the latter comprising in particular two metal cores preventing the passage of the sewing needles to the appropriate spots. In addition, this sewing solution only allows in practice a fairly low increase of the resistance to the tensile forces tending to separate the stacks B and C from the stack A.

### SUMMARY

The present disclosure provides a method for manufacturing a T-shaped composite part by resin transfer molding, which is easily industrializable and has an improved resistance towards the forces tending to separate from one another the two sections of the T.

The present disclosure provides a method for manufacturing a T-shaped composite part by resin transfer molding, comprising the followings steps:
constituting a preform with a substantially planar stack of plies and with two L-shaped stacks of plies;
placing said preform so that said L-shaped stacks meet between two cores of a resin-transfer molding tool;
inserting and removing fibers through said planar stack in a direction perpendicular or a quasi-perpendicular to this stack and so that to form loops inside the portions of said L-shaped stacks which are substantially perpendicular to said planar stack;
closing the molding tool;
injecting resin into the molding tool; and
heating the molding tool so as to cure the resin.

Thanks to this method in which the fibers enter and leave on the same face of the planar stack of plies, we can thus perform the consolidation of the junction area of the different stacks of the preform once the latter has been placed between the cores of the molding tool, which is much simpler to implement in the context of an industrial process: the movements of the sewing machine performing the fiber loops may indeed be limited to linear movements.

In addition, the orientation of the fibers forming the loops perpendicularly to the planar stack of plies, and the passage of these fibers in the portions of the L-shaped stacks of plies which are substantially perpendicular to the planar stack of plies, that is to say in fact in the base of the T, offers a particularly remarkable resistance towards the forces that tend to pull out the L-shaped stacks from the planar stack.

Following other features of the method according to the present disclosure:
said planar stack and said L-shaped stacks are assembled prior to the introduction of the preform between the two cores of the molding tool;
said L-shaped stacks are assembled, they are introduced between the two cores of the molding tool, and covered with said planar stack;
each of said L-shaped stacks and said planar stack are positioned one after the other in the molding tool;
loops of different lengths are formed;
slightly inclined loops are formed with respect to the direction perpendicular to said planar stack;
a first and a second group of loops are formed, the length and the inclination of said first group of loops with respect to the direction perpendicular to said planar stack being greater than those of said second group of loops.

The present disclosure also relates to a composite part obtained from the abovementioned method.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross sectional view of a composite part of the prior art, as described in the preamble of the present description;

FIG. 2 is a perspective view of this same part;

FIG. 3 is a sectional view of a composite part during manufacturing with the method of the present disclosure;

FIG. 4 is a cross sectional view of this part once manufactured; and

FIG. 5 is a cross sectional view of another part manufactured with the method according to the present disclosure.

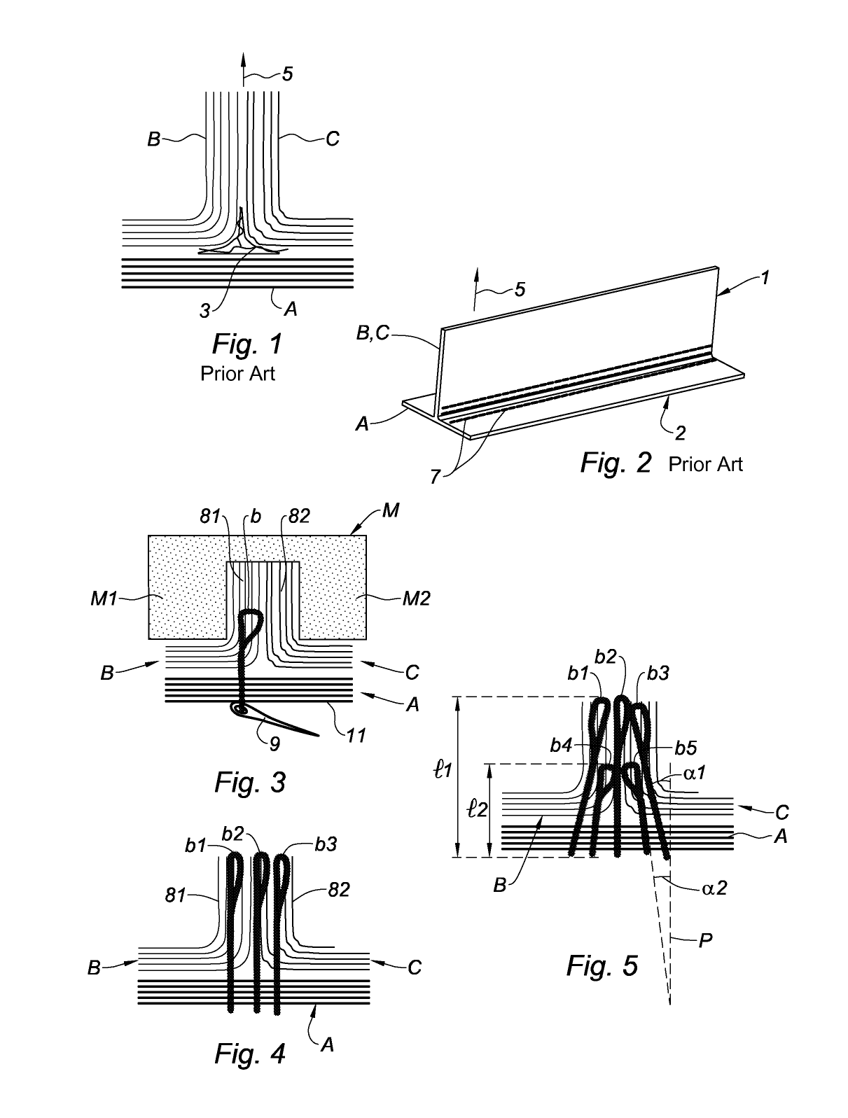

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring now to FIG. 3, on which we can see that the preform defined by the planar stack of plies A and by the two L, B and C-shaped stacks of plies is positioned on a molding tool M.

More specifically, the portions of the L, B and C-shaped stacks of plies are placed, which are substantially perpendicular to the planar stack of plies A, between the two metal cores M1 and M2 of the molding apparatus M.

Note that the planar stack of plies A can be assembled to the two L, B and C-shaped stacks of plies prior to the introduction of the thus formed preform between the two cores M1 and M2.

According to one form, we can begin by assembling the two L, B and C-shaped stacks of plies, then introducing them between the two cores M1 and M2, and finally cover them with the planar stack of plies A.

Still according to another form, we can position each of the L, B and C-shaped stacks of plies and the planar stack of plies A one after the other, in the molding tool M.

Whatever the retained assembly sequence is, we thus reach the configuration shown in FIG. 3, from which fiber loops b are performed inside the portions 81 and 82 of the L, B and C-shaped stacks of plies which are substantially perpendicular to the planar stack of plies A.

More specifically, by means of an automatic sewing machine including a needle 9, these fibers are inserted inside the planar stack of plies A from the free face 11 thereof, the fiber is penetrated inside the respective portion 81, 82 of each L, B and C-shaped stack of plies, the loop b is performed inside this portion, then the fiber is removed by the free face 11 of the planar stack of plies A, in the vicinity of the entry point of this fiber in this stack.

The general direction of the fiber, outside the loop B, is substantially perpendicular to the planar stack A, as it is seen in FIG. 3.

This operation is reproduced as many times as necessary, so as to obtain a plurality of fibers defining each of the loops b1, b2, b3 formed inside the portions 81 and 82 of the L, B and C-shaped stacks, these fibers having a general direction substantially perpendicular to the planar stack A.

This method of performing loops, allowing a machine to work on one face of the composite preform of plies, is commonly known as “tufting”.

Once these performed looped fibers are set up, the molding tool M is closed, and is injected under pressure inside the polymerizable resin, which will then fill all the interstices which are in the preform defined by the stacks of plies A, B, C.

This resin will particularly be positioned around the fibers forming the loops b1, b2, b3.

Once this resin introduction is performed, the molding tool M is subjected to a temperature rise, allowing the rapid polymerization of this resin.

The fibers forming the loops b1, b2, b3 allow to perform a very resistant reinforcement of the junction area of the three stacks of plies A, B, C.

In particular, these fibers allow obtaining an excellent resistance to the pulling out of the L, B and C-shaped plies with respect to the stack of plies A.

It will be further noted that the possibility of performing the tufting once the preform is on the molding tool M is of a great convenience from an industrial point of view, compared to conventional sewing operations as shown in FIG. 2, necessitating the movement of one or more sewing machines on several faces of the preform.

Of course, we can choose at will the features of the fibers forming the loops b1, b2, b3, as well as the shape and spatial distribution of these loops.

For example, these loops can be made with carbon yarn, and be spaced at a pitch of 3 mm relative to each other, penetrating to fifty millimeters inside the portions 81 and 82 of the L, B and C-shaped stacks.

As an example, the plies forming the stacks A, B and C may be formed of satin carbon.

The stack A may comprise, for example 20 plies, and the stacks B and C 5 plies each.

FIG. 5 shows one form in which the junction between the stacks of plies A, B, C is further reinforced compared to the form of FIG. 4.

In this form, we actually provide for a first group of loops b1, b2, b3 and a second group of loops b4, b5, the length l1 and the inclination α1 of the first group of loops b1, b2, b3 with respect to the direction perpendicular P to the planar stack A being greater than those l2, α2 of the second group of loops b4, b5.

Of course, the present disclosure is not limited to the forms described and shown, supplied as simple examples.

What is claimed is:

1. A method for manufacturing a T-shaped composite part by resin transfer molding, comprising the following steps:
constituting a preform with a substantially planar stack of plies and with two L-shaped stacks of plies;
placing said preform so that said L-shaped stacks meet between two cores of a resin transfer molding tool;
inserting and removing fibers through said planar stack in a direction perpendicular or quasi-perpendicular to said planar stack and so that loops are formed inside a portion of said L-shaped stacks which are substantially perpendicular to said planar stack;
closing the resin transfer molding tool;
injecting a resin into the resin transfer molding tool; and
heating the resin transfer molding tool to cure the resin.

2. The method according to claim 1, wherein said planar stack and said L-shaped stacks are assembled prior to the placing said preform between the two cores of the resin transfer molding tool.

3. The method according to claim 1, wherein said L-shaped stacks are assembled, introduced between the two cores of the resin transfer molding tool, and covered with said planar stack.

4. The method according to claim 1, wherein each of said L-shaped stacks and said planar stack are positioned one after the other in the resin transfer molding tool.

5. The method according to claim 1, wherein the loops have different lengths.

6. The method according to claim 1, wherein the loops are formed slightly inclined with respect to the direction perpendicular to said planar stack.

7. The method according to claim 1, wherein a first and a second groups of loops are formed, a length and an inclination of said first group of loops with respect to the direction perpendicular to said planar stack being greater than the corresponding length and inclination of said second group of loops.

8. A T-shaped composite part obtained by the method according to claim 1.
